(19) United States
(12) Patent Application Publication
(10) Pub. No.: US 2002/0159726 A1
(43) Pub. Date: Oct. 31, 2002

(54) Water-resistant cable

(76) Inventors: Tony Brown, Ewenny (GB); Nigel Shackleton, Littleborough (GB)

Correspondence Address: Finnegan, Henderson, Farabow,, Garrett & Dunner, L.L.P., 1300 I Street, N.W., Washington, DC, 20005-3315, US

(21) Appl. No.: 09/961,335

(22) Filed: Sep. 25, 2001

Related U.S. Application Data
(63) Continuation of application No. PCT/EP00/02516, filed on Mar. 22, 2000.
(60) Provisional application No. 60/127,582, filed on Apr. 2, 1999.

(30) Foreign Application Priority Data
Mar. 25, 1999 (EP) 99106042.7

(51) Int. Cl. G02B 6/44

(52) U.S. Cl. 385/109; 385/112

(57) ABSTRACT

An optical fiber cable having a tube in which is inserted at least one optical fiber and a mixture of a water-mediated expanding powder and a material with a particle size less than that of the water-mediated expanding powder is inserted in the tube. The percentage of the powder in the mixture is in an amount such as to block the flow of water to within a distance of less than about three meters from the point of ingress of the water in twenty-four hours and such as to bring about an increase in attenuation in the optical fiber, after it has been housed in the cavity, of less than 0.02 dB/km.

The present invention relates to a cable, in particular an optical fibre cable, which is resistant to the radial permeation and to the longitudinal propagation of water.

The present invention also relates to a method for maintaining a high resistance to the passage of water, both in the liquid state and in the vapour state, inside cables, in particular optical fibre cables.

Cables, and in particular optical fibre cables, are used in ambient conditions which include contact with water, both in liquid form and in vapour form.

The presence of water inside optical cables, and in particular close to optical fibres, results in reduction of the transmission capacities of the fibres.

The said reduction in the transmission capacities of the fibres is due in particular to the diffusion of water vapour through the coatings on the optical fibre and subsequent condensation of water at the ink-secondary coating and glass-primary coating interface. This condensation can lead to local detachment between the ink and the secondary coating or between the glass and the primary coating, giving rise to irregular mechanical stresses (“microbending”), which can cause attenuation of the signal transmitted.

Contact of optical fibres with liquid water can occur either following penetration of water from a poorly wrapped end (during storage or laying of the cable) or following accidental damage to the sheath itself.

The presence of water, in particular of water in the liquid state, and the possibility of its longitudinal propagation inside cables is also a possible cause of damage to the apparatus to which the cables are connected. In view of the above observations, it is therefore advantageous to block the propagation of water along the cable and to limit as much as possible the length of cable involved in this propagation which, after contact with water, will have to be decontaminated.

Contact of the optical fibres inside a cable with water in the vapour state occurs when this water permeates through the layers which make up the optical cable, thus being able to get inside to where the optical fibres are located. Up to quite high relative humidity values (typically of about 75-80%), the optical fibres are not adversely affected by the presence of water vapour and can even remain under such conditions for years. Above this threshold, the high humidity in contact with the surface of the optical fibres can lead to drawbacks similar to those caused by contact with liquid water (for example delamination, local detachment between glass and coating and/or detachment between the various layers of coating, microbending phenomena) which can result in increases in attenuation.

Lastly, prolonged contact of water (either liquid water or water in the vapour state) with the surface of the fibre, such as that which occurs after glass-primary coating delamination, can lead to a reduction in the mechanical strength of the glass part of the fibre.

A range of solutions for limiting or preventing the ingress of water into cables is disclosed in the prior art.

For example, to limit the penetration of liquid water into optical fibre cables, it is known practice to introduce a fluid blocking filling material, typically a fat or a thickened oil, into the structure of the cable in order to establish a physical barrier to the passage of water into the cable. These filling materials, which do not have any particular physicochemical interactions with the water, are also known as “inert stoppers”.

Examples of these inert fluid stoppers are disclosed in patents EP 811,864, U.S. Pat. No. 5,285,513, U.S. Pat. No. 5,187,763 and EP 541,007.

U.S. Pat. No. 5,751,880 describes an optical unit for an optical fibre cable comprising a plastic tube in which fibres are housed loosely. The tube has an outside diameter of 5 mm and an inside diameter of 4.5 mm, and is made of a material with a modulus of elasticity of less than 1500 MPa at 20° C. A sealing gel for preventing the penetration of water and for making the fibres run together smoothly is contained inside the plastic tube.

U.S. Pat. No. 5,671,312 describes an optical fibre cable in which the said fibres, each coated with its own acrylate coating, are assembled inside plastic tubes. A filling oil which goes into the empty spaces between the fibres is present inside these tubes. This oil has a viscosity of between 100 cPo and 5000 cPo. The purpose of this oil is to reduce the attrition between the fibres in the greatly reduced empty spaces between the fibres in the tubes.

The introduction of the said inert blocking filling materials into the structure of the optical cable during production is often laborious, in particular with tubes having a small diameter. Moreover, processing of the ends (“heads”) of these cables, which need to be wrapped so as to prevent any loss of the filling material, which is in a more or less viscous fluid state, is required. In addition, during installation and/or maintenance of the cable, in order to be able to make junctions between the different pieces of cable, it is necessary to wash off the blocking filling material from all of the components of the optical cable, and in particular from the optical fibres. This operation is often unpleasant for the person laying the cable and can result in damage to the optical fibres due to the action of the solvents and friction.

Another known solution for limiting the ingress of water into optical cables envisages the use of water-mediated expanding materials, i.e. substances capable of absorbing a certain amount of water, thereby increasing their volume. In contrast with the materials described above, these materials are also known as “active stoppers”.

Typically, these water-mediated expanding materials are in powder form distributed on supports made of fibrous plastic material, for example strips or yarns, on which this powder is applied, which are arranged close to the cable structures along which it is desired to impede the longitudinal propagation of water. U.S. Pat. No. 5,138,685 describes a cable comprising a laminated strip consisting of two superimposed layers of nonwoven fabric of polymer material, between which is placed a water-mediated expanding material in powder form.

U.S. Pat. No. 5,642,452 describes a cable comprising a yarn impregnated with water-mediated expanding material, in particular polyacrylic acid. This yarn is coiled around a central reinforcing element together with tubes containing the optical fibres which are filled with a conventional “inert” stopper. According to the disclosure given in that patent, this configuration is capable of preventing the longitudinal passage of water in the star-shaped areas created by the helical winding of the tubes around the central element.

U.S. Pat. No. 4,767,184 describes an optical cable with a grooved core, in which grooves are placed several strips of superimposed optical fibres, each coated with a film of resin containing a water-mediated expanding or swelling material. In combination with the strips of optical fibres with a coating containing water-mediated expanding material, a coating of the same material applied to the grooved core can be used, whereas in the grooves in which no strips of optical fibres are present it is necessary to use a powder made of water-absorbing material.

The Applicant has observed that if water-mediated expanding fibrous strips are used, during manufacture of the cable it is necessary to include an additional wrapping operation to apply these strips.

Moreover, the problem of undesired release of the water-mediated expanding powders, borne by the said strips, often arises, both during construction of the cable and in the constructed cable. The result of this is that the capacity of limiting the penetration of water can be reduced precisely where it is needed.

The Applicant has observed that by using a water-mediated expanding material in the form of powder, the optical fibres in contact with the granules of the said powder may be subjected to “microbending” phenomena, i.e. phenomena of uncontrolled localized folding due to direct contact of the fibres with the granules of the said powder. This causes a substantial increase in the attenuation of the signal propagated in the fibres, even independently of the presence of moisture.

Thus, by using a water-mediated expanding powder in contact with the optical fibres, it is possible to obtain undesired attenuation of the optical signal transmitted in the optical fibres on account of the microbending.

The Applicant has further observed that in order to avoid this drawback, it would be necessary to make the average size of the granules of the water-mediated expanding powder considerably smaller than the values currently available.

However, the Applicant has found that this reduction is not possible beyond a preset limit, corresponding to a particle size curve in which about 90% of the material has granule sizes of less than 80 μm, since powder ground smaller than this value loses many of its water-mediated expandability properties and thus its water-blocking capacity.

In addition, the Applicant has observed that an increase in the coefficient of attrition between one fibre and another and between the fibres and the inner wall of the tube are encountered when the water-mediated expanding powder is used. Besides the abovementioned attenuation of the signal, this can result in difficulties of smooth flow between the fibres and the tube, as is required, for example, during the operations of branching and termination of the cable, in which it would be necessary to run a length of tube relative to the fibres contained therein, in order to expose a suitable portion thereof.

According to the present invention, it has been found that a cable with tubes housing the optical fibres can be effectively protected against the longitudinal penetration of water through the tubes by placing a mixture inside these tubes and in contact with the optical fibres, this mixture comprising a first amount of water-mediated expanding powder and a second amount of inert powder, with a particle size less than that of the water-mediated expanding powder, substantially without any increases in attenuation in the fibres due to microbending phenomena. The inert powder advantageously comprises a material with lubricant properties, which thereby reduces the coefficient of attrition between the fibres and thus the attenuations induced by the friction between these fibres.

In addition, the Applicant has observed that, in an optical cable, and in particular in a cable with tubes, there are cavities of a first type, i.e. the cavities defined inside the tubes, and cavities of a second type, i.e. the cavities defined between the outer surface of the tubes and the sheath surrounding them. According to another aspect of the present invention, it has been found that the cavities inside the tubes, which can be blocked off only with difficulty by using viscous fluids on account of the small diameter of these tubes and the loss of filler associated with the feeding of the said viscous fluids therein, are advantageously protected by means of the abovementioned mixture of powders, while the space between the tubes can be effectively stopped up by means of a fluid stopper.

One aspect of the present invention thus relates to an optical fibre cable comprising a longitudinal cavity in which is inserted at least one optical fibre, characterized in that a mixture of powders comprising a first fraction of water-mediated expanding powder and a second fraction of an inert powder with a preset particle size, less than that of the said water-mediated expanding powder, are inserted into the said cavity, the said first and second fractions and the said preset particle size of the inert powder being selected in such a way as:

to limit the penetration of water in twenty-four hours along the said cavity to within a distance of less than three meters from the point of ingress of the said water, and

to bring about an increase in attenuation in the said optical fibre, after it has been housed in the said cavity, of less than 0.02 dB/km relative to the value of the non-cabled optical fibre.

The said fraction of water-mediated expanding powder is preferably between 40% and 80% by weight of the said mixture.

The said preset particle size of the said inert powder is preferably such that at least 90% by weight of the said inert powder is less than 40 μm in size.

In particular, the said inert powder is a material chosen from talc, graphite, molybdenum disulphide and PTFE in powder form.

The said inert powder is preferably talc.

The said water-mediated expanding powder is preferably poly(sodium acrylate).

The said water-mediated expanding powder preferably has a particle size such that at least 90% by weight of the said inert powder is less than 80 μm in size.

According to a preferred embodiment, the said cavity is a substantially tubular cavity with an inside diameter of less than 1.7 mm.

More particularly, the said cable further comprises an inner tube in which is loosely housed at least one tube, inside which is defined the said tubular cavity.

According to a preferred aspect of the present invention, a fluid stopper is inserted in the space between the said tubes and the said inner tube.

The said fluid stopper preferably comprises a polysiloxane.

According to one particular embodiment, the said fluid stopper comprises water-mediated expanding powder.

The said tubes are preferably made of a mixture comprising an ethylene/vinyl acetate copolymer.

For the purposes of the present invention, the term “inert powder” denotes a material in pulverulent form, which shows little or no increase in volume in the presence of water.

In the present description, the term “water-mediated expanding” or “swelling” material is intended to refer to a material capable of absorbing water from the surrounding environment and which, when placed in contact with the water, increases in volume, after absorption of a given amount of water, while remaining in the solid state. This increase in volume depends on the type of material, the contact time of this material with the water and the amount of water absorbed.

This definition includes materials which, on contact with water, show a volume increase of greater than 5% and preferably of at least 50% relative to the original volume, up to an increase of more than 200% relative to the original volume for substances with a particularly high capacity for water absorption.

A better understanding of the present invention will be gained from the following detailed description with reference to the attached drawings, in which:

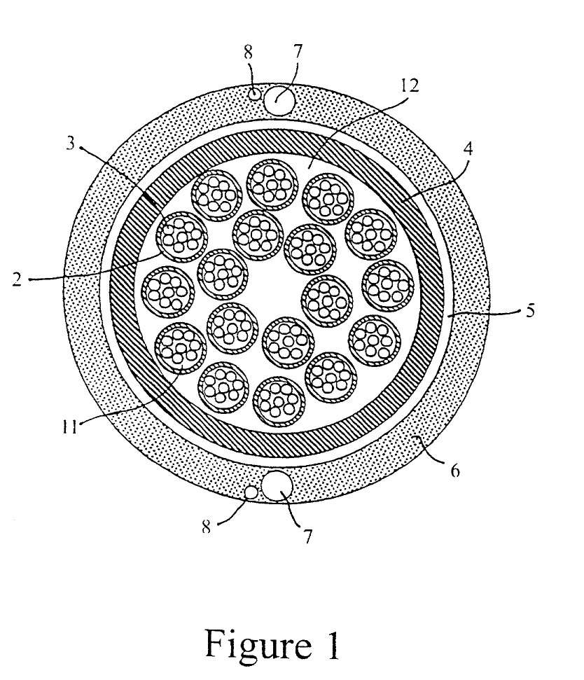

FIG. 1 is a schematic cross section of an example of an optical fibre cable according to the present invention, of the type containing tubes;

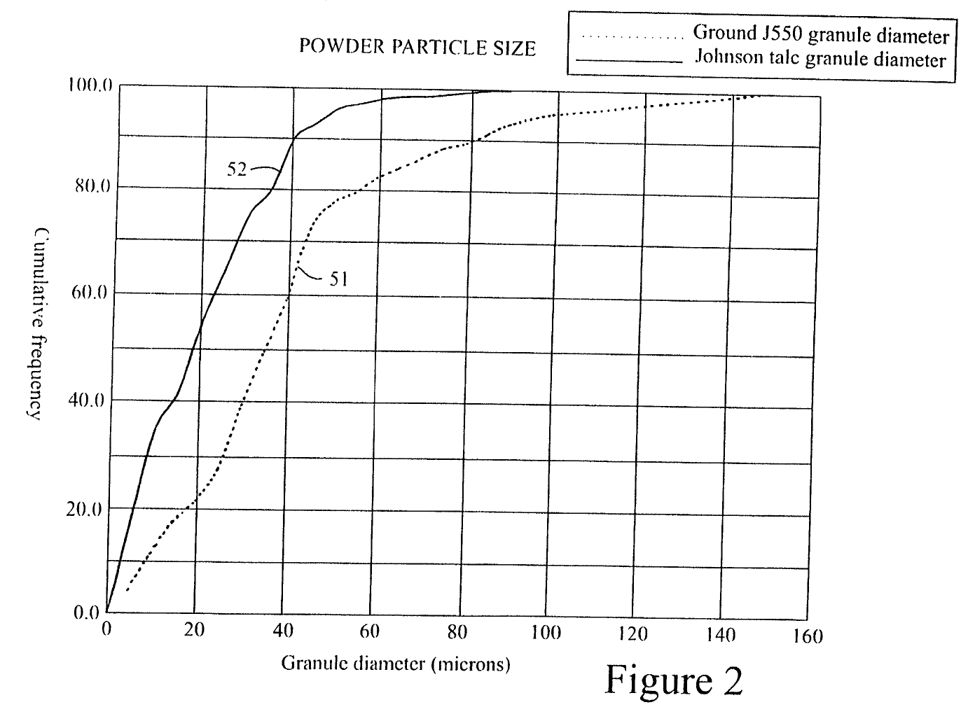

FIG. 2 is a graph which represents the particle size of a water-mediated expanding powder and a talc according to the present invention;

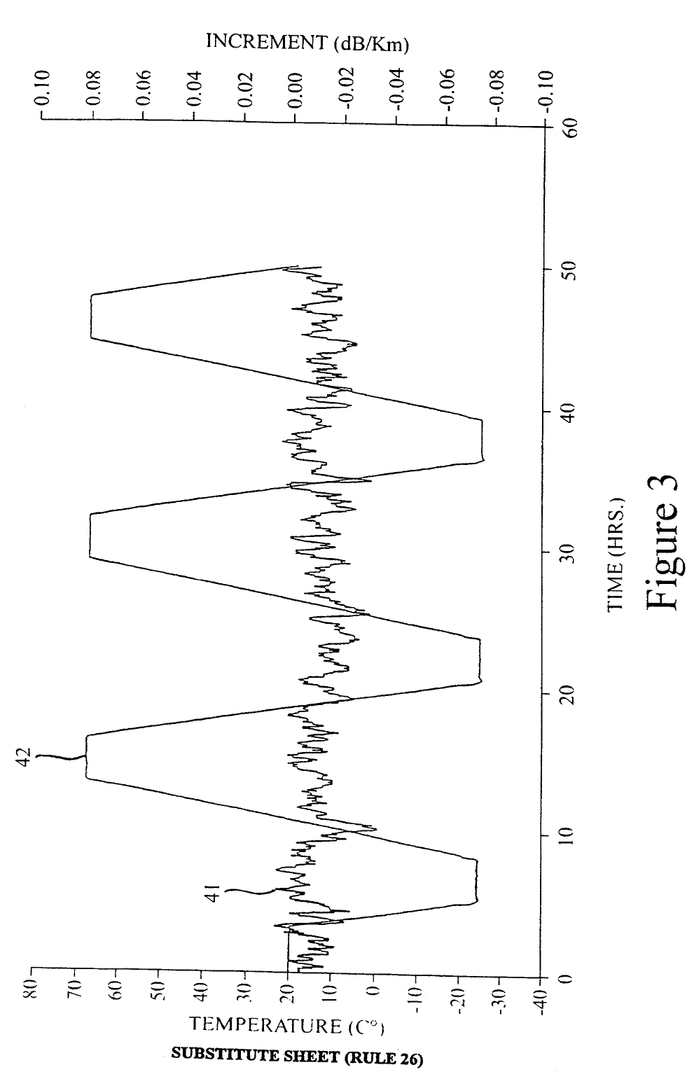

FIG. 3 is a graph of the variation in attenuation as a function of the temperature of a cable made according to the present invention;

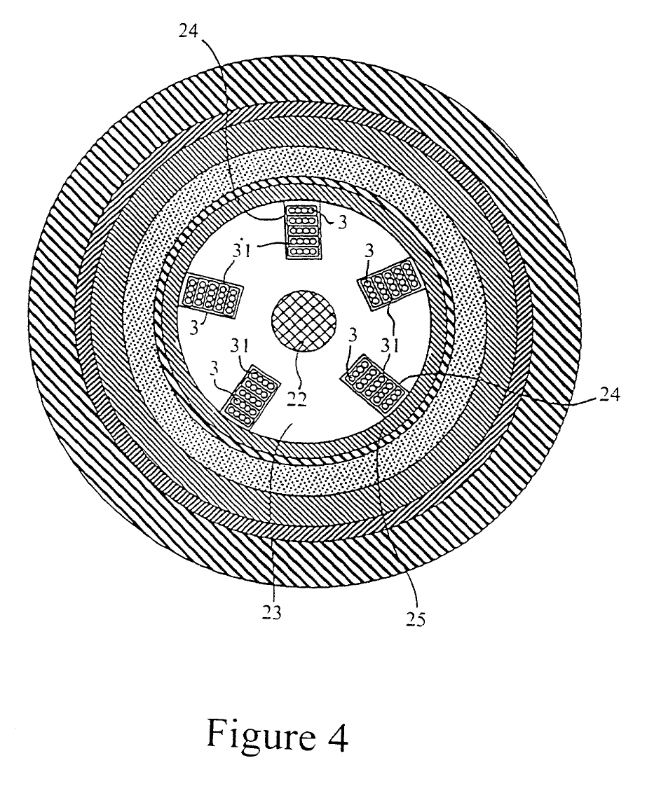

FIG. 4 is a schematic cross section of an example of an optical fibre cable according to the present invention, of the type with a grooved core.

A cable of the so-called tube type (in particular of the loose tube type), as represented in FIG. 1, contains one or more tubular elements or tubes 2 in which are housed optical fibres 3 arranged individually or combined in strips or the like. The optical fibres can be, for example, single-mode fibres, multi-mode fibres, dispersion-shifted (DS) fibres, non-zero dispersion (NZD) fibres, or fibres with a large effective area and the like, depending on the application requirements of the cable. They are generally fibres with an outside diameter usually of between 230 and 270 μm.

The number of tubular elements present (which may also be arranged on several layers) and the dimensions of these tubular elements depend on the intended capacity of the cable, as well as on the conditions under which this cable will be used.

For example, both cables with a single tubular element and cables with six, eight or more tubular elements, arranged in one or more layers (for example up to 48 tubes), are envisaged.

In one preferred embodiment, the tubes have an outside diameter of between 0.7 and 2 mm and an inside diameter of between 0.5 and 1.7 mm and are preferably made of polymer material.

A material which is suitable for making the tubes is, for example, an ethylene/vinyl acetate (EVA) copolymer or polyethylene (PE) or mixtures thereof, appropriately mixed with inorganic fillers in order to obtain the mechanical properties—of fire resistance and of level of emission of fumes—required for the specific application. These inorganic fillers can comprise, for example, calcium carbonate, magnesium hydroxide or aluminium hydroxide, or mixtures thereof.

One suitable material, to which inorganic fillers have already been added, is the material known as Pulsar 604 sold by BICC.

The material preferably has a modulus of elasticity of less than 4000 MPa throughout the temperature range in which the cable operates, i.e. typically between −40° C. and +70° C., so as not to give rise to excessive microbending stresses on the fibres during the daily and seasonal temperature cycles to which the cable is subjected.

To facilitate the cutting and removal of the tube during the operations of termination and branching of this cable, it is also preferable for the modulus of elasticity of the material constituting the tube to be sufficiently low in the temperature range envisaged for these operations (+30° C./0° C.), preferably less than or equal to 2500 MPa.

The cable also comprises an inner tube 4, which is made of plastic, for example polyethylene (preferably MDPE), EVA and the like, in which all the tubes 3 are inserted in a loose manner.

In one preferred embodiment, this inner tube has an outside diameter of between 4 and 17 mm and an inside diameter of between 2 and 14 mm, in relation to the capacities of the cable.

The tubes are preferably arranged in the said inner tube of the cable in an open helix pattern around the axis of the cable.

The expression “in an open helix” means that the tubes are bundled around the axis of the cable in sections with a first direction of winding (in S form), alternating with sections with an opposite direction of winding (in Z form).

This type of winding is defined as SZ winding.

The cable also comprises an outer tubular protective sheath 6 made of a polymer material, typically polyethylene (optionally with inorganic fillers added to optimize its flame resistance and its emission of fumes), EVA or PVC.

A layer of non-stick material 5 is advantageously inserted between the said outer tubular sheath 6 and the inner tube 4, this layer preventing the sheath and the inner tube from sticking together during extrusion of the cable. This material is, for example, a tape comprising a paper tape or a woven or nonwoven tape or a water-mediated expanding material. In the example described, the outer sheath has an outside diameter of between 3 and 25 mm and a thickness of between 0.5 and 3 mm.

One or more reinforcing members 7 arranged longitudinally along the cable are inserted in the thickness of the said outer tubular sheath 6. In one preferred embodiment, as illustrated in FIG. 1, two reinforcing members 7 are present, advantageously arranged diametrically opposite each other.

These members are preferably completely immersed in the said sheath and preferably consist of reinforcing rods of high-strength material, typically between 0.5 and 2.5 mm in size.

For illustrative purposes, the said reinforcing members are made of a composite material, such as glass resin or reinforced carbon fibre resin or aramide yarns (Kevlar®), or alternatively of a metallic material such as steel and the like.

In addition, a reinforcing member can be alternatively or additionally placed inside the inner tube 4 in an axial position.

In addition, or alternatively, a reinforcing member can consist of a layer of high-strength fibres such as, for example Kevlar® or the like, extending over some or all of the circumference of the cable.

Sheath-embedded wires 8 can be included in the outer tubular protective sheath 6, preferably located close to the said reinforcing members and aligned longitudinally with respect to the cable. These sheath-embedded wires can be made, for example, with aramide yarns or yarns coated with a water-mediated expanding material.

In one specific embodiment, the tube 4 can be omitted and the outer tubular sheath 6 can carry out the twofold function of an outer protective sheath and an inner tube.

In addition, this outer sheath can be of elliptic cross section or can have several reinforcing ribs, for example two or four opposing ribs, in some of which the reinforcing members are inserted. This embodiment is described, for example, in patent application EP 793,127.

In relation to specific requirements, further protective layers, for example metal or polymer layers, can also be present, both inside and outside the structure described.

A mixture 11 comprising a percentage of water-mediated expanding powder mixed with a fine-grain inert powder is inserted inside the tubes 2. In particular, this inert powder has a particle size less than that of the water-mediated expanding material.

The powder of fine particle size is preferably talc; in particular, the talc Johnson Baby Powder from Johnson & Johnson has proven to be suitable.

Other materials which are suitable for this purpose are graphite, molybdenum disulphide or polytetrafluoroethylene (PTFE) in powder form.

One example of a material which is suitable for use as a water-mediated expanding powder is an absorbent polymer based on poly(sodium acrylate) (“SAP”, super-absorbent polymer) known as Aqua Keep J550 produced by Sanyo.

This material is commercially available in a particle size distribution of between 50 μm and 1 mm, about 90% of the granules being less than 800 μm in size.

This particle size proved to be too large for use in proximity to optical fibres, and the water-mediated expanding powder was thus subjected to a grinding treatment, thus bringing down to a particle size which is still compatible with maintaining the water-mediated expanding properties of the powder (90% of the powder is less than 80 μm in diameter).

FIG. 2 is a graph in which curve 51 shows the particle size properties of the water-mediated expanding powder (Sanyo Aqua Keep JSSO) and curve 52 shows the properties of the powder of fine particle size (Johnson Baby Powder talc from Johnson & Johnson).

It can be seen from the two graphs that the particle size of the talc is less than that of the super-absorbent polymer; in point of fact, about 90% of the talc granules are less than about 40 μm in diameter and 90% of the granules of the water-mediated expanding powder are less than about 80 μm in diameter.

The mixture typically comprises from 40 to 80% by weight of water-mediated expanding powder and from 20 to 60% by weight of inert powder (talc).

The powder mixture described above can advantageously be introduced into the tubes by applying it to the fibres before extruding the inner tube around these fibres.

For example, the powder mixture can be applied by passing the fibres through a basin containing these powders which are kept stirring.

Alternatively, jets of powder carried by a compressed gas (for example air) can be applied to the fibres.

In order to improve the adhesion between the powders and the fibres in the section prior to extrusion of the tube, the fibres can be electrostatically charged.

The amount of mixture of water-mediated expanding powder and of inert powder present in a tube depends on the number of fibres and on the free volume present in the tube. Typically, a tube housing 8 fibres, with a diameter of 0.9 mm, can have a content of the mixture of water-mediated expanding powder and of inert powder of between 30 and 50 g/km, corresponding to about 4-7 g/km for each fibre.

In the case where the powder mixture is applied using electrostatic devices, the amount of powder mixture can be increased up to 100-120 g/km (in the case of this tube with 8 fibres). In this case, the fraction of water-mediated expanding powder in the mixture can be correspondingly less (as a guide 20-40%), in relation to the amount of powder mixture effectively introduced into the tube and to the desired distance of water penetration.

The tubes 2 are loosely housed inside the inner tube 4. A fluid stopper 12 is advantageously inserted into the empty spaces between one tube and another, this stopper occluding substantially all the spaces, thus preventing the penetration of water along the inner tube.

The choice of the type of stopper fluid is limited by the fact that it is in contact with the plastic material of the tubes 2. The reason for this is that, for certain plastic materials, contact with a hydrocarbon fluid causes damage, since this fluid extracts the plasticizer which may be present in the plastic material of the tube, thus making the tube rigid and fragile, and thus liable to break. Thus, it is necessary to select the plastic material of the tubes (and also of the inner tube 4) and the stopper fluid such that they are mutually compatible.

In addition, water-mediated expanding powder can be added to the stopper fluid so as to increase the efficacy of stopping up the interstitial areas between the tubes and between the tubes and the inner tube.

An example of one type of stopper fluid which is advantageously used in the present invention and which is compatible with tubes made of EVA is a silicone stopper fluid consisting of polydimethylsiloxane thickened with colloidal silica, sold under the name H55 by SICPA.

The table below illustrates the results of a number of ageing tests carried out on materials of possible use for preparing the tubes in the presence of stopper fluids.

These tests consist in checking the degradation of the mechanical properties of the material of the tubes due to accelerated ageing during contact with a fluid stopper.

The accelerated ageing test was carried out by preparing test pieces consisting of a tube 1 m long, and immersing the said test pieces, apart from the ends, in an open container containing the stopper fluid.

The containers containing the test pieces were then maintained at a temperature of 85° C. for 10 days.

After the ageing, the test pieces were extracted, the stopper fluid was mechanically washed off and the test pieces were subjected to mechanical tests. The results of the said tests are given in Table 1 below.

Table 1 compares the behaviour of tubes made of EVA, in particular the abovementioned Pulsar 604, with tubes made of plasticized PVC, in contact with the abovementioned silicone stopper fluid H55 and with a stopper fluid based on synthetic polyolefins thickened with an elastomer.

The quantities observed are the breaking load (BL), the elongation at break (EB) and the modulus of elasticity (E) of test pieces made with the two abovementioned plastics, both in their standard state and after accelerated ageing in air, in silicone stopper and in polyolefin-based stopper.

TABLE 1

| | PULSAR 604 | | | PVC | | |
|---|---|---|---|---|---|---|
| | BL, | | | BL, | | |
| | Mpa | EB, % | E, Mpa | Mpa | EB, % | E, Mpa |
| | (Δ, %) | (Δ, %) | (Δ, %) | (Δ, %) | (Δ, %) | (Δ, %) |
| Original | 16.8 | 120 | 137.3 | 10.5 | 155 | 19.9 |
| In air | 9.3 | 100 | 48.7 | 15.2 | 90 | 716.2 |
| | (−44.6) | (−16.6) | (−64.5) | (+44.7) | (−41.9) | (+3598) |
| Silicon | 14.9 | 110 | 143.3 | 17.9 | 25 | 749.7 |
| stopper H55 | (−11.3) | (−8.3) | (+4.3) | (+70.4) | (−83.8) | (+3767) |

| | | | | |
|---|---|---|---|---|
| Polyolefin- | Test pieces destroyed | 16.7 | 20 | 502.4 |
| based stopper | | (+59) | (−87) | (+2524) |

From analysis of the results of the table, the Applicant has observed a strong increase in the elastic modulus and a corresponding reduction in the elongation at break in the case of PVC, which means that the tube becomes very fragile and thus liable to break with both the stoppers used; in contrast, the use of Pulsar 604 in contact with the silicone stopper fluid H55 is satisfactory.

An outer layer of the tubes 2, or the inner tube 4 or a lining thereof, made of a solid water-stopper, for example a polyvinyl alcohol/polyvinyl acetate copolymer, can advantageously be present, in addition to or in replacement for the stopper fluid. The solid water-stopper can be either extruded, to form a layer of one or more of the abovementioned members, or in the form of taping.

In another alternative form, water-mediated expanding powder (in standard form or ground) can be used outside the tubes. In this case, since no fibres are present which may be subject to the microbending phenomena mentioned above, it is not necessary for the powder to be mixed with talc or the like.

### EXAMPLE 1

Test of Water Penetration into a Cable with a Mixture of Stopper Powders

The test consisted in subjecting an optical fibre cable to a constant head of one meter of water over the entire length of the cable, corresponding to a pressure of 0.1 bar, and in measuring the time taken by the water front to come to a complete stop inside the cable.

The optical fibre cable used in the present test had substantially the structure represented in FIG. 1, and in particular consisted of:

an outer sheath 6 made of high-density polyethylene, comprising two sheath-embedded wires 8 and two glass resin reinforcing members 7 1.9 mm in diameter.

inside the said sheath, eighteen tubes 2 (outside diameter of 1.1 mm and inside diameter of 0.9 mm) S/Z bundled (pitch 2 m and angle ±360°) and inserted loosely in an inner tube 4 made of MDPE (outside diameter 8.4 mm, inside diameter 6.4 mm); these tubes 2 are prepared in the abovementioned Pulsar 604;

a silicone grease with a viscosity of 120 Pa·s is inserted in the said inner tube 4;

a non-stick material made with a 70 μm thick paper tape 5 is inserted between the said inner tube and the said sheath;

eight NEON®-type single-mode optical fibres (with a coloured secondary coating) with a nominal diameter

of 250 μm, produced by Pirelli Cables, are placed inside each tube 2;

a mixture of stopper powders 11 comprising talc (Johnson Baby Powder from Johnson & Johnson) and Sanyo Aqua Keep J550 water-mediated expanding powder is placed inside the said tubes between the optical fibres; the mixture comprised 30% talc and 70% water-mediated expanding powder and was in an amount corresponding to about 30 g/km for each tube.

A glass column one meter long was filled with water containing a dye (methylene blue) to facilitate detection of the front of the fluid inside the cable, and was firmly connected to one end of the cable described above.

The test was carried out at room temperature on a cable 6 m long.

Following this test, the cable was checked, after 24 hours, to see whether it was capable of blocking the flow of the fluid into it to less than 3 m from the point of infiltration of this fluid.

### EXAMPLE 2

Test of Water Penetration into a Cable with an Inert Stopper Powder

In a second test, a cable of the same structure as described in Example 1 above was tested, using an amount of about 30 g/km of talc per tube inside the tubes.

It was found that one minute after starting the test, the water had run the entire length (6 m) of the cable used and came out at the opposite end.

### EXAMPLE 3

Test of Water Penetration into a Cable with a Water-Mediated Expanding Stopper Powder

In a third test, a cable of the same structure as that of Example 1 was tested, using an amount of -about 30 g/km per tube of water-mediated expanding powder inside the tubes.

After 24 hours, it was found that the cable was capable of blocking the flow of water inside it to less than 3 m from the point of infiltration.

### EXAMPLE 4

Test of Attenuation in a Tube with a Mixture of Stopper Powders

The attenuation per unit length of an optical signal transmitted in a length of tube using the powder mixture according to the invention, wrapped under tension on a reel, was measured using the OTDR technique (optical time domain reflectometry), which measures the amount of light back-scattered by the fibres.

The slope of the curve of the back-scattered light power measures the attenuation of the signal along the optical fibre.

A tube of the same structure as that described in Example 1 was used, containing a mixture of powders composed of 30% talc and 70% water-mediated expanding powder.

The tube tested was about 2 km long and was wound on a reel with a diameter of about 200 mm and a tension of 70 g.

From examination of the attenuation curves measured on the fibres contained in the tube, an average attenuation increase equal to about 0.01 dB/km was found, relative to the values found on the same non-cabled fibres.

It was also found that no significant degrees of attenuation were present.

The loss observed is entirely negligible in practice; this loss can probably be attributed to the state of mechanical stress due to the winding under tension of the tube on the reel on which the measurement was carried out. The structure of the finished cable protects the individual tubes from lateral stresses, and it is therefore expected that this slight loss would not be detectable under the operating conditions of the cable.

### EXAMPLE 5

Test of Attenuation in a Tube with an Inert Stopper Powder

Using a powder composed of 100% talc inside a tube, the curves of the back-scattered power measured were found to be substantially in agreement with those for the uncabled fibres, revealing a substantially zero increase in attenuation. However, in this cable, the water penetration was not halted; it was found that the water in this tube ran through 3 meters of tube in 30 seconds.

### EXAMPLE 6

Test of Attenuation in a Tube with a Water-Mediated Expanding Stopper Powder

Using a powder composed of 100% Sanyo Aqua Keep J550 water-mediated expanding powder (ground to the particle size given in FIG. 2) inside a tube, the attenuation curves measured showed a significant increase in the average attenuation relative to that of the uncabled fibres (typically greater than about 0.1 dB/km). In addition, the curve observed shows localized degrees of attenuation, which are thought to be due to seizing and overpressures (caused, for example, by lumps of powder), localized along the tube.

### EXAMPLE 7

Variation in Attenuation During Thermal Cycles

A cable of the same structure as that of Example 1 was tested, using inside the tubes a mixture comprising 30% talc and 70% water-mediated expanding powder (ground), in an amount corresponding to about 30 g/km for each tube.

The variation in attenuation during thermal cycles between −25 and +70° C. were measured at a wavelength of 1550 nm. The results, recorded automatically during the said thermal cycles, are given in FIG. 3, which is the graph of the attenuation 41 on the cable during these thermal cycles (represented by curve 42). As found in curve 41, no substantial increase in the attenuation over time was revealed.

Thus, by inserting a mixture comprising a water-mediated expanding powder and a material with a particle size less than that of the water-mediated expanding powder into the tubes containing the optical fibres, blocking of the penetration of water into the cable is successfully achieved, at the same time avoiding any considerable attenuation of the signal transmitted.

It was advantageously found that the inert powder, in particular talc, gives rise to a lubricant action between the fibres inside the tubes, thus lowering their coefficient of attrition.

In the type of cable described above, the space which the abovementioned mixture needs to occupy is generally very small, in particular in the case of particularly small tubes.

During construction of the cable, inserting a viscous fluid as a stopper into such tubes is very difficult or impossible (at the production speeds of commercial interest) on account of the very high losses of charge which the fluid would suffer when fed into these tubes.

In contrast, the mixture of water-mediated expanding powder and talc is applied beforehand onto the fibres, as described above, and the fibres are then inserted into the tube. When carried out in this way, the operation ensures that this mixture occupies substantially all the spaces inside the tube without placing excessive stress on the tube itself.

During installation, maintenance, termination or branching of the cable to gain access to the optical fibres, it is necessary to cut into and take off a suitable portion of the tube and the fibres themselves will have to be freed of the presence of these powders.

The operation is facilitated with an optical cable according to the invention, since the powder mixture makes it easier to take off the tube and, in addition, this mixture is easy to remove using a jet of compressed air, whereas this would not be possible using a fluid stopper. The various members mentioned above can be prepared according to the known techniques, in particular, for example, the tubes and the sheath can be prepared by extrusion.

The present invention has been described with reference to one preferred embodiment, consisting of an optical fibre cable comprising a tube in which one or more optical fibres are housed independently.

The present invention also applies to cables in which two or more optical fibres are combined in ribbons or the like.

In particular, in the case of ribbons, each ribbon comprises a plurality of optical fibres, each of which is covered with a primary coating and a coating common to the optical fibres of the ribbon. The said primary coating is formed of a first layer which is in direct contact with the fibres, and a second layer outside the first layer.

In addition, the present invention also applies to cables of different structure, for example cables in which the fibres are housed in grooved cores, either separately or combined in ribbons.

A cable of this type, as given in FIG. 4, has a reinforcing member 22, made, for example, of glass resin, in the radially innermost position, on which member is a grooved core 23 (typically extruded), made of PE, PP or (totally or partly) of a water-soluble solid material, on the outer side of which are formed grooves 24 which extend in a continuous helix or in an s-z alternate pattern along the entire outer surface of the said core, to house the optical fibres 3 therein. In the example illustrated, the optical fibres 3 are combined in ribbons.

In particular, in each of the grooves 10 are housed, superposed radially on each other, several optical fibre ribbons, five in the embodiment shown.

An optical fibre ribbon is formed from several optical fibres 3, for example four, which have polymer coatings consisting essentially of a laminated primary coating, combined with each individual fibre 3, and a common coating 31, outside the laminated primary coating, which surrounds all the optical fibres belonging to the same ribbon and holds them together.

The grooved core 23 is then coated with one or more layers 25, which close the grooves to the outside, these layers being made of polymer or metal or combined material; these coatings can be made either in the form of an extruded sheath or as a longitudinal or helical polymeric or metallic winding.

Further layers for protecting the cable may be present outside the closure layer 25.

A detailed description of one example of this type of cable is given in patent EP 503,469 in the name of the Applicant.

In a cable of the abovementioned type, the stopper mixture described above can be introduced inside the grooves 24 and between each layer of optical fibre ribbons, thus creating a barrier to the movement of water inside these grooves and, at the same time, acting as a lubricant to limit the attrition as described previously for a cable containing tubes.

In general, with reference to the dimensions given above and the penetration test described, it is found that the stopper powder mixture described above can be used effectively in optical fibre cables in which, between the fibres and the cavity in which they are inserted, there is an empty space not greater than 70% relative to the total volume of the cavity, and preferably not greater than 50%.

In the case of free spaces greater than the values indicated above, the efficiency of the powder mixture according to the present invention in terms of limiting the longitudinal propagation of water will have to be assessed specifically, in particular with reference to the specific conditions of use envisaged and the amount of powder mixture applied per unit length of cable.

1. Optical fibre cable comprising a longitudinal cavity in which is inserted at least one optical fibre (3), characterized in that a mixture of powders (11) comprising
a first fraction of water-mediated expanding powder and
a second fraction of an inert powder with a preset particle size, less than that of the said water-mediated expanding powder,
is inserted into the said cavity,
the said first and second fractions and the said preset particle size of the inert powder being selected in such a way as:
to limit the penetration of water in twenty-four hours along the said cavity to within a distance of less than three meters from the point of ingress of the said water, and
to bring about an increase in attenuation in the said optical fibre, after it has been housed in the said cavity, of less than 0.02 dB/km relative to the value of the non-cabled optical fibre.

2. Optical fibre cable according to claim 1, characterized in that the said fraction of water-mediated expanding powder is between 40% and 80% by weight of the said mixture.

3. Optical fibre cable according to claim 1, characterized in that the said preset particle size of the said inert powder is such that at least 90% by weight of the said inert powder is less than 40 μm in size.

4. Optical fibre cable according to claim 1, characterized in that the said inert powder is a material chosen from talc, graphite, molybdenum disulphide or PTFE in powder form.

5. Optical fibre cable according to claim 4, characterized in that the said inert powder is talc.

6. Cable according to claim 1, characterized in that the said water-mediated expanding powder is poly(sodium acrylate).

7. Optical fibre cable according to claim 1, characterized in that the said water-mediated expanding powder has a particle size such that at least 90% by weight of the said inert powder is less than 80 μm in size.

8. Optical fibre cable according to claim 1, characterized in that the said cavity is a substantially tubular cavity with an inside diameter of less than 1.7 mm.

9. Cable according to claim 1, characterized in that it further comprises an inner tube (4) in which is loosely housed at least one tube (2), inside which is defined the said tubular cavity.

10. Cable according to claim 8, characterized in that a fluid stopper is inserted in the space between the said tubes (2) and the said inner tube (4).

11. Cable according to claim 9, characterized in that the said fluid stopper comprises a polysiloxane.

12. Cable according to claim 9, characterized in that the said fluid stopper comprises water-mediated expanding powder.

13. Cable according to claim 8, characterized in that the said tubes are made of a mixture comprising an ethylene/vinyl acetate copolymer.
